(19) United States
(12) Patent Application Publication
(10) Pub. No.: US 2017/0315855 A1
(43) Pub. Date: Nov. 2, 2017

(54) METHOD OF DETECTING ANOMALIES ON APPLIANCES AND SYSTEM THEREOF

(71) Applicants: AGT INTERNATIONAL GMBH, ZURICH (CH); TECHNICAL UNIVERSITY OF MUNICH, MUNICH (DE)

(72) Inventors: Christoph DOBLANDER, Garching (DE); Hans-Arno JACOBSEN, Munchen (DE)

(21) Appl. No.: 15/144,101

(22) Filed: May 2, 2016

(51) Int. Cl. G06F 11/07

(52) U.S. Cl. CPC G06F 11/079; G06F 11/0757; G06F 11/0709; G06F 11/0736

(57) ABSTRACT

A method, system and computer program product, the method comprising: obtaining transition probabilities, each transition probability associated with transition of a home appliance between states; receiving sensor readings indicating behavior of the home appliance; identifying by the processor a transition event occurring in the sensor readings; determining by the processor a source cluster and a destination cluster associated with the transition event; determining by the processor a duration indicator associated with the transition event; determining by the processor a transition probability by looking up in the transition probabilities, a probability associated with the duration indicator, the source cluster and the destination cluster; comparing by the processor the transition probability to a threshold; and responsive to the transition probability exceeding a threshold, providing an indication of abnormal behavior of the home appliance to a user.

### TECHNICAL FIELD

The presently disclosed subject matter relates to anomaly detection in data streams, and more particularly to identifying anomalies in home appliances.

### BACKGROUND

Problems of identifying abnormal behavior in home appliances from parameter measurements have been recognized in the conventional art and various techniques have been developed to provide solutions, for example:

Chandola, V.; Banerjee, A.; Kumar, V. in “Anomaly Detection for Discrete Sequences: A Survey” published in Knowledge and Data Engineering, IEEE Transactions on, vol. 24, no. 5, pp. 823-839, May 2012 provides an overview of the existing research for the problem of detecting anomalies in discrete/symbolic sequences. The objective is to provide a global understanding of the sequence anomaly detection problem and how existing techniques relate to each other. The survey classifies the existing research into three distinct categories, based on the problem formulation that they are trying to solve. These problem formulations are: 1) identifying anomalous sequences with respect to a database of normal sequences; 2) identifying an anomalous subsequence within a long sequence; and 3) identifying a pattern in a sequence whose frequency of occurrence is anomalous. The essay shows how these problem formulations are characteristically distinct from each other and discusses their relevance in various application domains. Techniques from many disparate and disconnected application domains that address each of these formulations are reviewed. Within each problem formulation, techniques are grouped into categories based on the nature of the underlying algorithm. For each category, a basic anomaly detection technique is provided, and it is shown how the existing techniques are variants of the basic technique. This approach shows how different techniques within a category are related or different from each other. The categorization reveals variants and combinations that have not been used before for anomaly detection. A discussion is provided of relative strengths and weaknesses of different techniques. The adaptation of techniques developed for one problem formulation to a different formulation is shown, thereby providing adaptations to solve the different problem formulations. The applicability of the techniques that handle discrete sequences to other related areas such as online anomaly detection and time series anomaly detection is shown.

Sridhar Ramaswamy, Rajeev Rastogi, and Kyuseok Shim in “Efficient algorithms for mining outliers from large data sets” published in Proceedings of the 2000 ACM SIGMOD international conference on Management of data (SIGMOD '00). ACM, New York, N.Y., USA, 427-438 propose a formulation for distance-based outliers that is based on the distance of a point from its k-th nearest neighbor. Each point is ranked on the basis of its distance to its k-th nearest neighbor and the top n points in this ranking are declared to be outliers. In addition to developing relatively straightforward solutions to finding such outliers based on the classical nested-loop join and index join algorithms, a partition-based algorithm is developed for mining outliers. This algorithm first partitions the input data set into disjoint subsets, and then prunes entire partitions as soon as it is determined that they cannot contain outliers. This results in substantial savings in computation. The results from a real-life NBA database highlight and reveal several expected and unexpected aspects of the database. The results from a study on synthetic data sets demonstrate that the partition-based algorithm scales well with respect to both data set size and data set dimensionality.

Xing Xiaoxue; Guan Xiuli; Shang Weiwei in “Continuous attribute discretization algorithm of Rough Set based on k-means” published in IEEE Workshop on Advanced Research and Technology in Industry Applications (WARTIA), 2014, pp. 1384-1387, 29-30 Sep. 2014 applies the Rough Set theory to preprocess the data, continuous attribute discretization is the necessary and key step. A discretization method based on the k-means algorithm is introduced. Using this method, the wholly attributes can be classified into two categories. Four sets of data on UCI database were chosen to verify the performance of the presented method. In this experiment, the k-means algorithm was used to implement the data discretization firstly; and then they are used to do attributes reduction through rough set; finally, the classification result is validated with KNN (k-Nearest Neighbor algorithm, k=10) classifier classification algorithm. The experimental results show that this method presented in this paper can improve the efficiency of discretization, and effectively reduce the break points.

Bhattacharya, S.; Qazi, B. R.; Elmirghani, J. M. H., in “A 3-D Markov Chain Model for a Multi-Dimensional Indoor Environment” published in Global Telecommunications Conference (GLOBECOM 2010), 2010 IEEE, pp. 1-6, 6-10 Dec. 2010 propose a pico-cellular airport traffic model which supports Engset distributed fresh call arrival process and General distributed handoff process with Dynamic Channel Allocation (DCA). The proposed model enables load balancing using DCA and uses a three-dimensional Markov chain to compute traffic congestion and call congestion for any kind of traffic streams, including Pure Chance Type-I (PCT-I) or Pure Chance Type-II (PCT-II). The application of the proposed model is illustrated in assessing indoor mobility to evaluate QoS parameters. The proposed airport traffic model is fairly general in the sense that it is not restricted by number of users, user mobility or range of offered load, and can be reduced to predict congestion for Poisson distributed fresh call arrival processes and General distributed handoff processes.

An article published in http://stockcharts.com/school/doku.php?id=chart school:chart_analysis:fibonacci_time_zones explores the concept of Fibonacci Time Zones which are vertical lines based on the Fibonacci Sequence. These lines extend along the X axis (date axis) as a mechanism to forecast reversals based on elapsed time.

Vinod Muthusamy, Haifeng Liu, and Hans-Arno Jacobsen in “Predictive Publish/Subscribe Matching” published in ACM Distributed Event-based Systems (DEBS), pages 14-25, July 2010, present a publish/subscribe capability: the ability to predict the likelihood that a subscription will be matched at some point in the future. Composite subscriptions consisting of temporal and logical operators are efficiently represented by a set of finite state machines and rules. The algorithm trains a Markov model to an application's event workload, and predicts the probability that a given subscription will match within a window in the future event stream. Evaluations demonstrate that the memory and processing costs of the algorithm scales well with the number of subscriptions, and the prediction precision is high, especially when the workload characteristics do not change rapidly. A comparison with a hand-crafted Markov model using real data traces shows that the algorithm consumes much less memory and processing power, and still delivers prediction precision that approaches the hand-crafted model's. This is especially impressive since the algorithms lack any of the domain expertise embedded in the hand-crafted model.

The references cited above teach background information that may be applicable to the presently disclosed subject matter. Therefore the full contents of these publications are incorporated by reference herein where appropriate for appropriate teachings of additional or alternative details, features and/or technical background.

### General Description

The disclosed subject matter provides for identifying anomalies in the operation or functionality of devices such as home appliances, by identifying transitions between states of a measured parameters associated with the device, wherein the transitions are of low probability. The disclosure provides for early detection of problems or misuse of devices, thus avoiding further damages, saving energy, or the like.

In accordance with certain aspects of the presently disclosed subject matter, there is provided a method of for identifying anomalies in data streams using a processor operatively connected to a memory, the method comprising: receiving sensor readings associated with a home appliance of a home appliance type; clustering by a processor the sensor readings into a plurality of clusters; extracting by the processor from the sensor readings transition features associated with a transition, in accordance with the plurality of clusters, the transitions indicating state changes in the home appliance, each state associated with a cluster; and based on the transition features, determining transition probabilities between states of the home appliance for a plurality of transition time indicators and accommodating the transition probabilities in the memory, wherein the transition probabilities are adapted for detecting anomalies in transitions occurring in further sensor readings, thus identifying abnormal behavior of another appliance of the home appliance type. Within the method clustering is optionally performed by a K-means clustering process. Within the method clustering is optionally performed by a DBscan clustering process. Within the method determining the transition probabilities optionally comprises: indicating a time duration for each transition; determining number of transitions for each combination of source and destination for each time duration; and normalizing the number of transitions. Within the method, determining the number of transitions for each time duration optionally comprises Markov chain sampling.

In accordance with other aspects of the presently disclosed subject matter, there is provided a computer-implemented method for identifying anomalies in data streams indicating behavior of a home appliance using a processor operatively connected to a memory, the method comprising: obtaining transition probabilities, each transition probability associated with transition of a home appliance between states; receiving sensor readings indicating behavior of the home appliance; identifying by the processor a transition event occurring in the sensor readings; determining by the processor a source cluster and a destination cluster associated with the transition event; determining by the processor a duration indicator associated with the transition event; determining by the processor a transition probability by looking up in the transition probabilities, a probability associated with the duration indicator, the source cluster and the destination cluster; comparing by the processor the transition probability to a threshold; and responsive to the transition probability exceeding a threshold, providing an indication of abnormal behavior of the home appliance to a user. Within the method the duration indicator is optionally a discretized transition duration associated with the transition event. Within the method, the discretized transition duration is optionally an index of a Fibonacci number larger than the transition duration. Within the method the sensor readings optionally refer to one or more items selected from the group consisting of: power consumption; current; voltage; fluid flow; temperature; and humidity. Within the method, obtaining the transition probabilities optionally comprises: receiving sensor readings associated with a home appliance; clustering the sensor readings into a plurality of clusters; extracting from the sensor readings transition features associated with a transition, in accordance with the plurality of clusters, the transitions indicating state changes in the home appliance, each state associated with a cluster; and based on the transition features, determining transition probabilities between states of the home appliance for a plurality of transition time indicators. Within the method clustering is optionally performed by a K-means clustering process. Within the method clustering is optionally performed by a DBscan process. Within the method determining the transition probabilities comprises: indicating a time duration for each transition; determining number of transitions for each combination of source and destination for each time duration; and normalizing the number of transitions. Within the method determining the number of transitions for each time duration optionally comprises Markov chain sampling.

In accordance with other aspects of the presently disclosed subject matter, there is provided a computerized system for projecting a machine learning model, the system comprising a processor, wherein: the processor is configured to obtain transition probabilities, each transition probability associated with transition of a home appliance between states; the processor is configured to receive sensor readings indicating behavior of the home appliance; the processor is configured to identify by the processor a transition event occurring in the sensor readings; the processor is configured to determine a source cluster and a destination cluster associated with the transition event; the processor is configured to determine a duration indicator associated with the transition event; the processor is configured to determine a transition probability by looking up in the transition probabilities, a probability associated with the duration indicator, the source cluster and the destination cluster; the processor is configured to compare the transition probability to a threshold; and the processor is configured to provide an indication of abnormal behavior of the home appliance to a user determine, responsive to the transition probability exceeding a threshold. Within the system, the duration indicator is optionally a discretized transition duration associated with the transition event and wherein the discretized transition duration is an index of a Fibonacci number larger than the transition duration. Within the system, obtaining the transition probabilities optionally comprises: receiving sensor readings associated with a home appliance; clustering the sensor readings into a plurality of clusters; extracting from the sensor readings transition features associated with a transition, in accordance with the plurality of clusters, the transitions indicating state changes in the home appliance, each state associated with a cluster; and based on the transition features, determining transition probabilities between states of the home appliance for a plurality of transition time indicators. Within the system, clustering is optionally performed by a K-means clustering process or by a DBScan clustering process. Within the system, determining the transition probabilities optionally comprises: indicating a time duration for each transition; determining number of transitions for each combination of source and destination for each time duration; and normalizing the number of transitions.

In accordance with other aspects of the presently disclosed subject matter, there is provided a computer program product comprising a computer readable storage medium retaining program instructions, which program instructions when read by a processor, cause the processor to perform a method comprising: obtaining transition probabilities, each transition probability associated with transition of a home appliance between states; receiving sensor readings indicating behavior of the home appliance; identifying by the processor a transition event occurring in the sensor readings; determining by the processor a source cluster and a destination cluster associated with the transition event; determining by the processor a duration indicator associated with the transition event; determining by the processor a transition probability by looking up in the transition probabilities, a probability associated with the duration indicator, the source cluster and the destination cluster; comparing by the processor the transition probability to a threshold; and responsive to the transition probability exceeding a threshold, providing an indication of abnormal behavior of the home appliance to a user.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized flow chart of a method for detecting abnormal behavior in devices, in accordance with certain embodiments of the presently disclosed subject matter;

FIGS. 2A and 2B illustrate a non-limiting schematic example of determining the transition probabilities, in accordance with certain embodiments of the presently disclosed subject matter;

FIG. 3 illustrates a non-limiting schematic example of determining a probability for a transition event, in accordance with certain embodiments of the presently disclosed subject matter; and

FIG. 4 illustrates a generalized schematic block diagram of an apparatus for detecting abnormal behavior in devices, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating”, “determining” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities.

The terms “non-transitory memory” and “non-transitory storage medium” are used herein should be expansively construed to include any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The disclosure relates to identifying abnormal behaviors in devices such as home appliances. It will be appreciated that in some cases it may take a long time after a problem in a device occurs until it is noticed, at which point in time it may be too late or more expensive to correct the situation. By identifying that an unlikely transition has occurred between states of a device, early problem discovery may be enabled which may avoid a problematic situation.

For example, a refrigerator door left open may be discovered before the temperature within the refrigerator increases enough to be noticed. In another example, by identifying that the filters of an air-conditioner need to be cleaned, energy may be saved and the air-condition engine can operate avoid excessive work.

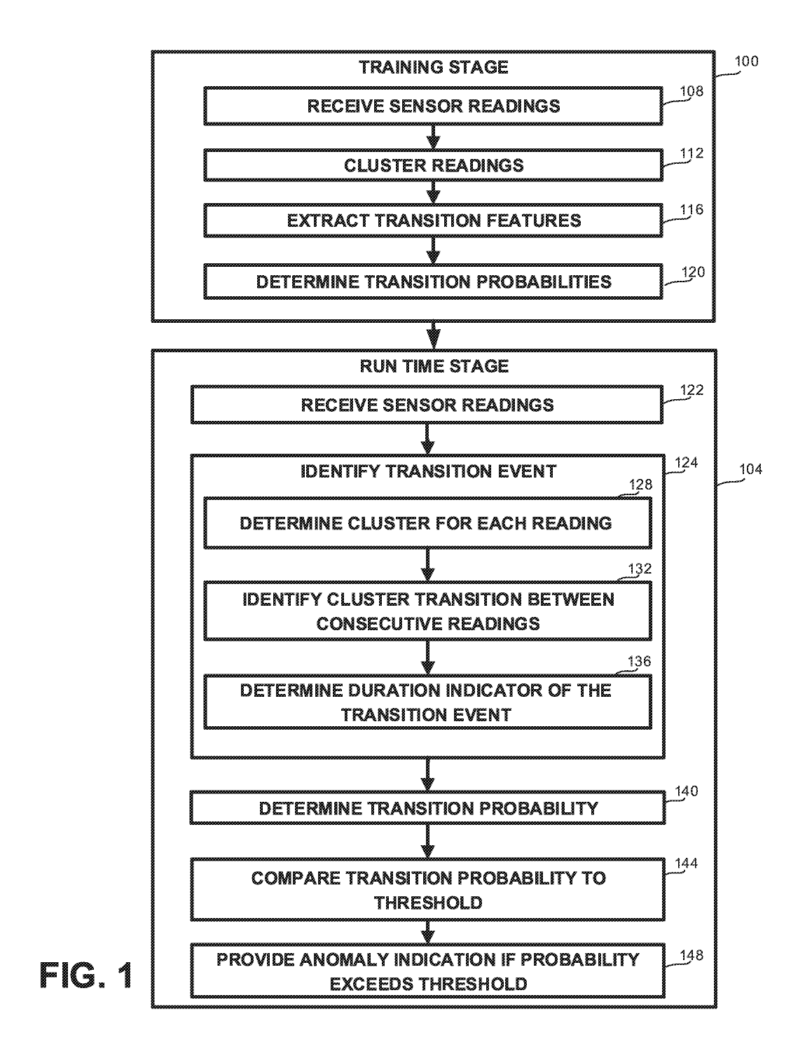

Bearing this in mind, attention is drawn to FIG. 1, there is illustrated a generalized flow chart of a method for detecting abnormal behavior in devices, such as but not limited to home appliances, for example refrigerators, air conditioners, washing machines, or others, in accordance with certain embodiments of the presently disclosed subject matter.

In some embodiments of the invention, the method comprises a training stage 100 and a runtime stage 104, each of which comprising multiple steps as detailed below.

During training stage 100 the normal behavior of a specific device such as a home appliance, or a device type such as a home appliance type may be learned, such that deviations from this behavior can then be detected, as they may indicate problems with the device.

On step 108, sensor readings may be received, for example as a data stream. The sensor readings may comprise readings of parameters associated with the device itself, such as current, voltage, temperature within the device, pressure, or the like. Additionally or alternatively, the readings may include environmental parameters, such as temperature in the environment of the device, pressure, light, noise, or any other measureable parameter. The sensor readings may be associated with time stamps, which may be absolute and indicate the time, or relative and indicate the time since measurements started. Alternatively, the measurements may be assumed to be taken at fixed time intervals, such that the same period of time elapses between any two consecutive measurements.

It will be appreciated that the sensor readings are not limited to a single parameter or to one dimensional parameter. Rather, readings may be received which relate to two or more parameters, such as voltage and temperature. Additionally or alternatively, the readings may relate to one or more multi-dimensional parameters, such as two-dimensional coordinates, or the like.

On step 112, the readings may be clustered into groups based on their values, using any desired clustering method, such as but not limited to K-means clustering but may include other methods such as K-Histograms, or DBSCANs. It will be appreciated that if readings are received from multiple sensors, or from one or more multi-dimensional sensors, then more complex clustering methods may be more appropriate, e.g., DBSCAN or Ward's Method.

The clustering results include two or more clusters, each having a cluster ID. For example, in K-means clustering, the cluster ID may be the centroid of a cluster.

Each reading is associated with one of the clusters and is closer to the centroid of the respective cluster than to the centroids of other clusters.

On step 116, transition features may be extracted from the readings and the clusters. A transition is identified when two consecutive measured values are associated with two different clusters. The features associated with each transition may thus comprise a source cluster, a destination cluster, and a transition duration, i.e., a period of time or number of measurements for which the measured values were associated with the first cluster prior to the transition. In some embodiments, the transition durations may be discretized to obtain transition indicators. In some embodiments, the discretization may use fixed intervals. However, in other embodiments, the discretization may use other scales, for example Fibonacci numbers. Extracting the transition features is further detailed in association with steps 128, 132 and 136 below.

It will be appreciated that the resulting features, obtained by discretization of the values as done by clustering, disctretization of time, and detecting the transitions may be viewed as Markov Chains. It will be appreciated that Markov chains are typically referred to as being memory-less, i.e., a transition is independent of a previously occurred transition. Additionally or alternatively Markov chains with memory may be used, typically referred to as “Additive Markov Chains” or “Markov chain of order m”, wherein m indicates the number of past states the transition depends on.

On step 120 the transition probabilities may be determined, for example by normalizing the numbers of all transitions associated with a given duration indicator and a given source cluster. The probabilities may thus indicate the probability of transition to a given destination cluster for a given transition duration and given source cluster.

The transition probabilities may then be stored and used for determining anomalies during runtime.

It will be appreciated that the training stage may be performed for a device type by a manufacturer and utilized for manufactured devices during usage. Alternatively, the training stage may be performed for each device when installed or when usage starts, and used later on. Even further, the training may be updated continuously or at times.

For runtime stage 104, the transition probabilities as determined on training stage 104 may be obtained. The transition probabilities may be calculated based on a training period, received with the device, received separately from another source, updated, or the like.

On step 122, sensor readings may be received, for example as a data stream, which may be received continuously, discretely, or the like. The readings may refer to the same parameter(s) for which training was performed.

On step 124, transition events may be identified within the received readings. On step 128, each reading may be associated with one of the clusters determined on step 112, for example by determining the cluster whose centroid is closest to the reading.

On step 132, transition may be identified as two consecutive readings being associated with two different clusters, such that a first reading is associated with a source cluster and a second reading is associated with a destination cluster.

On step 136, the transition duration may be determined as the period of time or the number of readings associated with the source cluster prior to the transition. A transition indicator may be obtained by time discretization thereof. The time discretization may be performed as the time discretization performed during training stage 100, i.e., using fixed time intervals, fixed number of readings, Fibonacci series, or the like. The transition indicator may also be obtained by a clustering technique, e.g. K-Means or others.

On step 140, the probability of the transition may be determined, by looking up at the received transition probabilities for the entry corresponding to the transition duration, the source cluster and destination cluster.

On step 144, the retrieved probability may be compared against a threshold.

On step 148, if the probability is below the threshold, this may indicate that the transition may be unlikely and may indicate abnormal behavior of the device, and an anomaly indication may be provided, for example by sending a message to a user, such as an instant message or a text message being sent to a mobile device of a user, an e-mail message sent to an e-mail account of a user, a message or a phone call initiated to an emergency center, or the like.

It is noted that the teachings of the presently disclosed subject matter are not bound by the flow chart illustrated in FIG. 1, and the illustrated operations can occur out of the illustrated order.

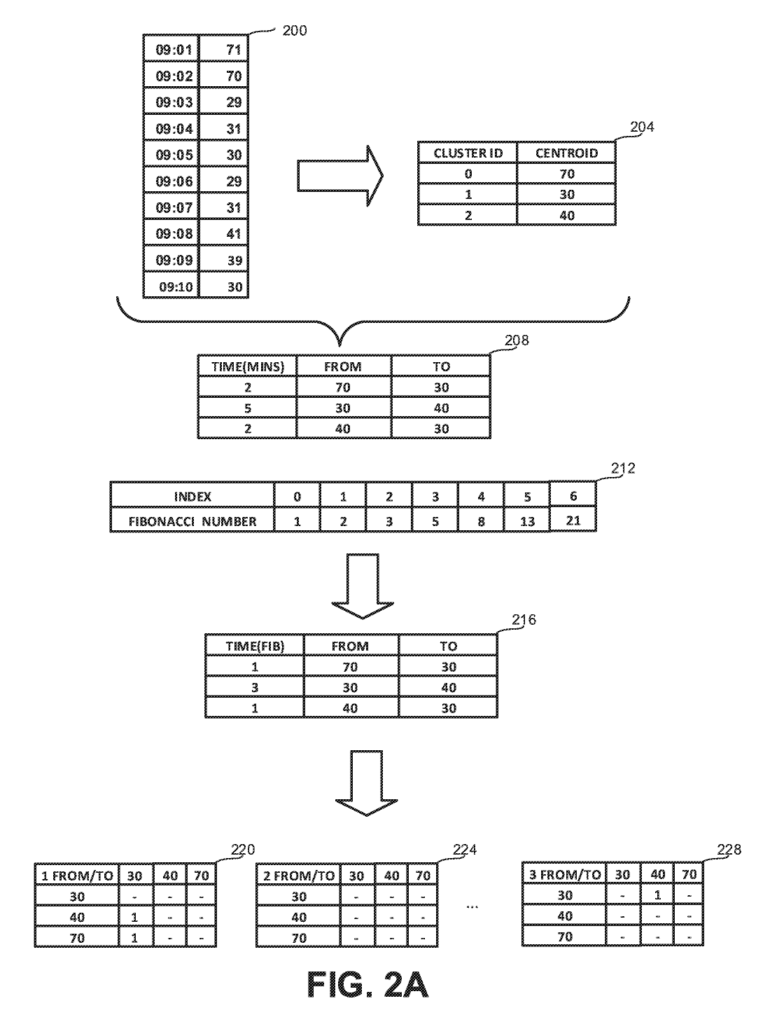

Referring now to FIG. 2A and FIG. 2B, showing an example of determining transition probabilities as described on training stage 100 of FIG. 1, and using the transition probabilities as described in runtime stage 104 of FIG. 1.

In the example of FIG. 2A, the values shown in table 2 (200) may be received for the respective times. For example, a reading of 71 may be received for 09:01. The values of FIG. 2 may refer to any measured value, such as electrical power consumption, electrical current, electrical voltage, temperature, or the like.

The values may then be clustered, using for example K-means clustering to obtain the clusters shown in table 204. Thus, cluster 0 has a centroid of 70, cluster 1 has a centroid of 30, and cluster 2 has a centroid of 40. It will be appreciated that the centroid is not necessarily a value that appeared in the measurements.

Transitions between clusters may then be identified within the readings of table 200. Thus, it can be seen that two minutes after the start of the readings, at 09:03, there was a transition between readings close to 70 (cluster 0) and readings close to 30 (cluster 1); after further five minutes there was a transition to values close to 40 (cluster 2); and after two more minutes a transition to a reading of 30 (cluster 1). The times and centroids of the involved clusters are summed in table 208.

Table 212 shows a series of Fibonacci numbers and their respective indices.

Table 216 shows table 208 in which the duration time in minutes has been converted to an index of the first Fibonacci number larger than the duration. Thus, the value of two is associated with Fibonacci index 1, while the value of five is associated with Fibonacci index 3. If the series had contained a transition having a duration of 18, then the Fibonacci number exceeding it is 21, and the transition would have been associated with the Fibonacci index of 6.

Then, a table may be constructed for each Fibonacci index. Thus, for the index of 1, table 220 may be created, showing that one transition occurred from 40 to 30, and another occurred from 70 to 30.

No transition occurred for the index of 2, thus table 224 is empty.

Table 228 shows the only transition that occurred within this time indicator, being from 30 to 40.

Referring now to FIG. 2B, showing tables 300, 304 and 308 for time indicators 1, 2 and 3, respectively. It should be noted that for better demonstrating the normalization process, tables 300, 304 and 308 are different from tables 220, 224 and 228, but may have been obtained for a different series of sensor readings.

Each row in each table may then be normalized, obtaining normalized tables 320, 324 and 328. Thus, the second row of table 300 is normalized from {1, 1, 0} to {0.5, 0.5.0}, the first row of table 308 is normalized from {0, 2, 1} to {0, 0.67, 0.33}.

It will be appreciated that representing the data as the tables discussed above is exemplary only and any other data structure may be used to represent the probabilities.

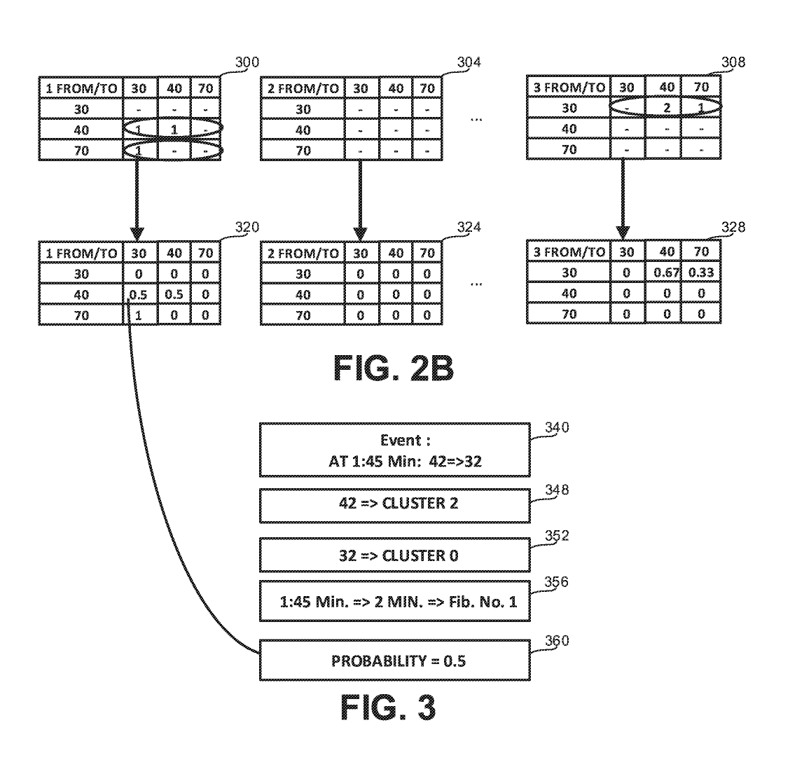

Referring now to FIG. 3, demonstrating steps 128, 132, 136 and 140 of FIG. 1 for determining a probability for a transition event.

An event 340 is received, in which at 1:45 minutes into the measurements a transition from a measurement of 42 to a measurement of 32 occurred.

On step 348 it is determined that the first measurement of the transition, being 42, is associated with cluster 2 having a centroid of 40.

On step 352 it is determined that the second measurement of the transition, being 32, is associated with cluster 0 having a centroid of 30.

On step 356 it is determined that the next Fibonacci number larger than the transition duration, being 1:45 minutes, is 2, which is associated with a Fibonacci index of 1.

Therefore table 320, associated with Fibonacci index of 1 is examined. The second row is associated with a source cluster having a centroid of 40, and the first entry in the row relates to transition to a destination cluster having a centroid of 30, which has a probability of 0.5.

Thus, the transition identified in the measurements has a probability of 0.5. Depending on a threshold associated with the device, this probability may or may not indicate an abnormal behavior and an anomaly indicator may or may not be issued to a user. It may be assumed that 0.5 is above the threshold for many cases, since such transition occurs in half the cases, and therefore an anomaly indication will not be provided, but this is not necessarily so.

It will be appreciated that in some cases multiple transition probabilities may be considered. For example, two or more transitions within a predetermined time period, each having a probability slightly above the threshold may be considered as an anomaly, too.

It will also be appreciated that different thresholds may be associated with differ tables or even different rows in the tables. For example, transition to high temperatures which endanger the home appliance may have a lower threshold than other transitions.

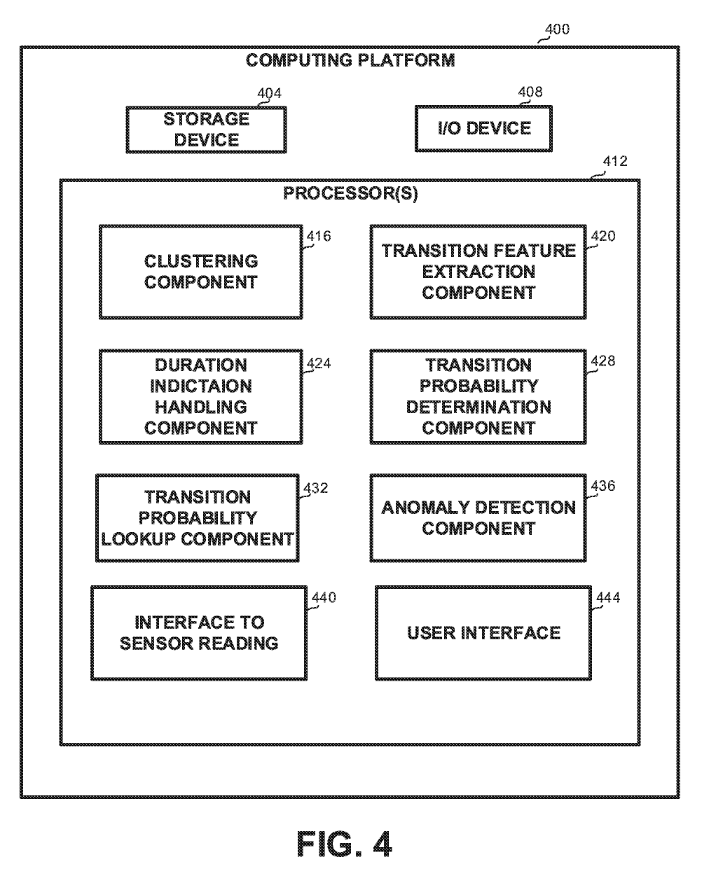

Referring now to FIG. 4, illustrating a functional diagram of a system for detecting anomalies in devices such as home appliances. The illustrated system comprises a computing platform 400 configured to execute the method of FIG. 1 and operatively coupled to a measurement device associated with or in the environment of a home appliance.

Computing platform 400 may comprise a storage device 404. Storage device 404 may be a hard disk drive, a Flash disk, a Random Access Memory (RAM), a memory chip, or the like. In some exemplary embodiments, storage device 404 may retain program code operative to cause processor 412 to perform acts associated with any of the subcomponents of computing platform 400.

In some exemplary embodiments of the disclosed subject matter, computing platform 400 may comprise an Input/Output (I/O) device 408 such as a display, a pointing device, a keyboard, a touch screen, or the like. I/O device 408 may be utilized to provide output to and receive input from a user.

Computing platform 400 may comprise one or more processor(s) 412. Processor 412 may be a Central Processing Unit (CPU), a microprocessor, an electronic circuit, an Integrated Circuit (IC) or the like. Processor 412 may be utilized to perform computations required by computing platform 400 or any of it subcomponents, such as steps of the method of FIG. 1.

It will be appreciated that processor 412 can be configured to execute several functional modules in accordance with computer-readable instructions implemented on a non-transitory computer-readable storage medium. Such functional modules are referred to hereinafter as comprised in the processor.

Processor 412 may comprise clustering component 416 for receiving a series of values, for example values of readings of a parameter associated with a device. Clustering component 416 may then determine two or more clusters each having a centroid, such that each value is associated with one of the clusters. Clustering component 416 may use K-means clustering or any other clustering method currently known or that will become known in the future.

Processor 412 may comprise transition feature extraction component 420 for determining transition within a received series of values, wherein each transition may be associated with a source cluster, a destination cluster and a transition duration.

Processor 412 may comprise duration indication handling component 424 for discretizing the transition duration, for example using a Fibonacci series.

Processor 412 may comprise transition probability determination component 428 for determining the probabilities of each transition during training stage 100, for example determining tables 320, 324 and 328.

Processor 412 may comprise transition probability lookup component 432 for looking up a probability of a given transition, for example during runtime stage 104.

Processor 412 may comprise anomaly detection component 432 for comparing one or more transition probabilities to thresholds, and determining whether the transition may indicate an abnormal behavior.

Processor 412 may comprise interface to sensor readings 440 for receiving readings from one or more sensors associated with one or more devices, wither during training stage 100 or during runtime 104. The readings may be received by directly connecting to the device, from estimating conditions in the environment, by a remote computing platform through a communication channel, or in any other manner.

Processor 412 may comprise user interface 444 for receiving input from a user or providing output to a user, such as alert indications. User interface 444 may exchange information with a user utilizing I/O device 408.

The components detailed above may be implemented as one or more sets of interrelated computer instructions, executed for example by processor 412 or by another processor. The components may be arranged as one or more executable files, dynamic libraries, static libraries, methods, functions, services, or the like, programmed in any programming language and under any computing environment.

It will be appreciated that some components, such as clustering component 416 may not be present on a device coupled to a monitored device, but only to a system used during the training stage 100 for determining of the probability tables. On the other hand, components such as transition probability lookup component 432 may be present only in runtime stage 104 in a device coupled to a monitored appliance, or on a remote computing platform accessible from a computing platform receiving the measurements.

In some embodiments, each device may perform training stage 100 as well runtime stage 104 for a particular device, in which case all components may be present.

It is noted that the teachings of the presently disclosed subject matter are not bound by the computing platform described with reference to FIG. 4. Equivalent and/or modified functionality can be consolidated or divided in another manner and can be implemented in any appropriate combination of software with firmware and/or hardware and executed on one or more suitable devices.

The system can be a standalone entity, or integrated, fully or partly, with other entities, which may be directly connected thereto or via a network.

It is also noted that whilst FIG. 1 may be performed by the system of FIG. 4, this is by no means binding, and the operations can be performed by elements other than those described herein, in different combinations, or the like.

For purpose of illustration only, the description is provided for devices such as home appliances. Those skilled in the art will readily appreciate that the teachings of the presently disclosed subject matter are, likewise, applicable to any other electrical, mechanical, electro-mechanical or other devices, intended for domestic, industrial, commercial, or other devices.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

What is claimed is:

1. A computer-implemented method for identifying anomalies in data streams using a processor operatively connected to a memory, the method comprising:
receiving sensor readings associated with a home appliance of a home appliance type;
clustering by a processor the sensor readings into a plurality of clusters;
extracting by the processor from the sensor readings transition features associated with a transition, in accordance with the plurality of clusters, the transitions indicating state changes in the home appliance, each state associated with a cluster; and
based on the transition features, determining transition probabilities between states of the home appliance for a plurality of transition time indicators and accommodating the transition probabilities in the memory,
wherein the transition probabilities are adapted for detecting anomalies in transitions occurring in further sensor readings, thus identifying abnormal behavior of another appliance of the home appliance type.

2. The method of claim 1, wherein clustering is performed by a K-means clustering process.

3. The method of claim 1, wherein clustering is performed by a DBscan clustering process.

4. The method of claim 1, wherein determining the transition probabilities comprises:
indicating a time duration for each transition;
determining number of transitions for each combination of source and destination for each time duration; and
normalizing the number of transitions.

5. The method of claim 3, wherein determining the number of transitions for each time duration comprises Markov chain sampling.

6. A computer-implemented method for identifying anomalies in data streams indicating behavior of a home appliance using a processor operatively connected to a memory, the method comprising:
obtaining transition probabilities, each transition probability associated with transition of a home appliance between states;
receiving sensor readings indicating behavior of the home appliance;
identifying by the processor a transition event occurring in the sensor readings;
determining by the processor a source cluster and a destination cluster associated with the transition event;
determining by the processor a duration indicator associated with the transition event;
determining by the processor a transition probability by looking up in the transition probabilities, a probability associated with the duration indicator, the source cluster and the destination cluster;
comparing by the processor the transition probability to a threshold; and
responsive to the transition probability exceeding a threshold, providing an indication of abnormal behavior of the home appliance to a user.

7. The method of claim 5, wherein the duration indicator is a discretized transition duration associated with the transition event.

8. The method of claim 6, wherein the discretized transition duration is an index of a Fibonacci number larger than the transition duration.

9. The method of claim 5, wherein the sensor readings refer to at least one item selected from the group consisting of: power consumption; current; voltage; fluid flow; temperature; and humidity.

10. The method of claim 5, wherein obtaining the transition probabilities comprises:
receiving sensor readings associated with a home appliance;
clustering the sensor readings into a plurality of clusters;
extracting from the sensor readings transition features associated with a transition, in accordance with the plurality of clusters, the transitions indicating state changes in the home appliance, each state associated with a cluster; and
based on the transition features, determining transition probabilities between states of the home appliance for a plurality of transition time indicators.

11. The method of claim 10, wherein clustering is performed by a K-means clustering process.

12. The method of claim 10, wherein clustering is performed by a process selected from the group consisting of: DBscan, K-Histograms and Ward's Method.

13. The method of claim 10, wherein determining the transition probabilities comprises:
indicating a time duration for each transition;
determining number of transitions for each combination of source and destination for each time duration; and
normalizing the number of transitions.

14. The method of claim 13, wherein determining the number of transitions for each time duration comprises Markov chain sampling.

15. A computerized system for projecting a machine learning model, the system comprising a processor, wherein:
the processor is configured to obtain transition probabilities, each transition probability associated with transition of a home appliance between states;
the processor is configured to receive sensor readings indicating behavior of the home appliance;
the processor is configured to identify by the processor a transition event occurring in the sensor readings;
the processor is configured to determine a source cluster and a destination cluster associated with the transition event;
the processor is configured to determine a duration indicator associated with the transition event;
the processor is configured to determine a transition probability by looking up in the transition probabilities, a probability associated with the duration indicator, the source cluster and the destination cluster;
the processor is configured to compare the transition probability to a threshold; and
the processor is configured to provide an indication of abnormal behavior of the home appliance to a user determine, responsive to the transition probability exceeding a threshold.

16. The system of claim 15, wherein the duration indicator is a discretized transition duration associated with the transition event and wherein the discretized transition duration is an index of a Fibonacci number larger than the transition duration.

17. The system of claim 15, wherein obtaining the transition probabilities comprises:
receiving sensor readings associated with a home appliance;
clustering the sensor readings into a plurality of clusters;
extracting from the sensor readings transition features associated with a transition, in accordance with the plurality of clusters, the transitions indicating state changes in the home appliance, each state associated with a cluster; and
based on the transition features, determining transition probabilities between states of the home appliance for a plurality of transition time indicators.

18. The system of claim 17, wherein clustering is performed by a process selected from the group consisting of: DBscan, K-Histograms and Ward's Method.

19. The system of claim 17, wherein determining the transition probabilities comprises:
indicating a time duration for each transition;
determining number of transitions for each combination of source and destination for each time duration; and
normalizing the number of transitions.

20. A computer program product comprising a computer readable storage medium retaining program instructions, which program instructions when read by a processor, cause the processor to perform a method comprising:
obtaining transition probabilities, each transition probability associated with transition of a home appliance between states;
receiving sensor readings indicating behavior of the home appliance;
identifying by the processor a transition event occurring in the sensor readings;
determining by the processor a source cluster and a destination cluster associated with the transition event;
determining by the processor a duration indicator associated with the transition event;
determining by the processor a transition probability by looking up in the transition probabilities, a probability associated with the duration indicator, the source cluster and the destination cluster;
comparing by the processor the transition probability to a threshold; and
responsive to the transition probability exceeding a threshold, providing an indication of abnormal behavior of the home appliance to a user.
